(19) United States
(12) Patent Application Publication
(10) Pub. No.: US 2012/0126188 A1
(43) Pub. Date: May 24, 2012

(54) PHTHALATE-FREE CHEMILUMINESCENT FORMULATIONS

(75) Inventor: Jeffrey D. Schrimmer, Highland Park, IL (US)

(73) Assignee: I PEE HOLDING LLC, Vernon Hills, IL (US)

(21) Appl. No.: 12/952,008

(22) Filed: Nov. 22, 2010

(51) Int. Cl. C09K 11/00

(52) U.S. Cl. 252/700

(57) ABSTRACT

A phthalate-free chemiluminescent formulation and a device containing such phthalate-free chemiluminescent formulation are provided. The phthalate-free chemiluminescent formulation includes phthalate-free solvents such as triethyl citrate and acetyl tributyl citrate.

### BACKGROUND OF THE INVENTION

This invention generally relates to chemiluminescent formulations, and more particularly to phthalate free chemiluminescent formulations.

Chemiluminescence is used in glow products such as glow sticks, glow necklaces, children's toys, safety devices and the like. Chemiluminescent formulations include chemical substances that convert a chemical energy into cool light through an exothermic reaction. In such a reaction, the energy released from the exothermic reaction is manifested not as heat, but as light. The released energy is absorbed by electrons in certain molecules, and causes the electrons to jump to a higher level (an excited state). As the electrons in the excited state return to the lower ground state, they release energy that can be seen as a photon of light. This process is referred to as chemiluminescence.

The chemiluminescence process is different from photoluminescent fluorescence and phosphorescence, both of which occur after the excited state of a molecule is produced from its ground state by absorption of light energy. Thus, fluorescent species emit light only while being irradiated. Phosphorescent species may appear to emit light without being irradiated, but this emitted energy had to have been absorbed at an earlier time. Chemiluminescent reactions, however, produce light without any prior absorption of radiant energy.

Commercially available glow products typically utilize a chemiluminescent reaction between hydrogen peroxide and an oxalate ester. This oxidation reaction produces two molecules of carbon dioxide, and a released energy that transfers to a fluorescent dye molecule. The glow products typically include two chemical components, which are separated by a packaging. When desired, a user can break the part of packaging that separates the two components to initiate a chemiluminescent reaction. The two chemical components include an oxalate component and an activator component. The oxalate component generally includes an oxalate ester and a solvent, and the activator component generally includes hydrogen peroxide and a solvent. Further, a fluorescer compound and a catalyst for enhancing luminescence intensity and lifetime control are typically included in one of the component solutions.

Conventionally, a phthalate-type solvent, such as dimethyl phthalate and dioctyl phthalate, is used as a solvent for the chemical components of chemiluminescence. The phthalate-type solvents provide good peroxide stability, good peroxide and oxalate solubility, good luminescent performance, and storage stability. However, studies have shown that phthalate exposure can cause endocrine disruptions and other health problems. Further, recently, it has been made unlawful in various countries to use some phthalate compounds in children's toys or child care articles.

WO 94/19421 discloses a phthalate free chemiluminescent activator solution comprising a peroxide compound in a solvent selected from acetyl trialkyl citrates, trialkyl citrates, n-alkyl-arylenesulfonamides, dialkyl adipates, pentaerythritol tetrabenzoate, glyceryl tribenzoate and mixtures thereof. U.S. Pat. No. 6,126,871 teaches a chemiluminescent activator solution including triethyl citrate, particularly the triethyl citrate formed from organic titanates using the method described in U.S. Pat. No. 5,055,609, and an equimolar mixture of sodium perborate and salicylic acid to improve chemiluminescent light output.

The present invention provides an improved phthalate free chemiluminescent formulation. These and other advantages of the invention, as well as additional inventive features, will be apparent from the description of the invention provided herein.

### BRIEF SUMMARY OF THE INVENTION

In one aspect, the invention provides a phthalate-free chemiluminescent formulation including a chemiluminescent component and an activator component. The chemiluminescent component includes an oxalate and a phthalate-free solvent. The activator component includes hydrogen peroxide and a phthalate-free solvent. The phthalate-free chemiluminescent formulation also includes a fluorescer compound. The chemiluminescent component and the activator component are mixed together to produce a chemiluminescent light.

In one embodiment, the oxalate is bis(2,4,5-trichlorophenyl-6-carbopentoxyphenyl)oxalate. In any of the above described phthalate-free chemiluminescent formulations, the phthalate-free solvent for the chemiluminescent component and the phthalate-free solvent for the activator component can be the same solvent or different solvents. In another embodiment, at least one of the phthalate-free solvent for the chemiluminescent component and the phthalate-free solvent for the activator component is a triethyl citrate. In yet another embodiment, at least one of the phthalate-free solvent for the chemiluminescent component and the phthalate-free solvent for the activator component is an acetyl tributyl citrate. In a different embodiment, the phthalate-free solvent for the chemiluminescent component is an acetyl tributyl citrate. Further, in some embodiments, the phthalate-free solvent for the activator component is a pure triethyl citrate formed without using an organic titanate.

In any of the above described phthalate-free chemiluminescent formulations, the fluorescer compound can be included in the chemiluminescent component or the activator component, or both.

Any of the above described phthalate-free chemiluminescent formulations can include a chemiluminescent component comprising between about 5 wt. % and about 15 wt. % bis(2,4,5-trichlorophenyl-6-carbopentoxyphenyl)oxalate, and between about 85 wt. % and 95 wt. % acetyl tributyl citrate.

Any of the above described phthalate-free chemiluminescent formulations can include an activator component comprising between about 1 wt. % and about 5 wt. % of hydrogen peroxide; and between about 0.003 wt. % and about 0.008 wt. % sodium salicylate; and between about 95 wt. % and about 99 wt. % of pure triethyl citrate formed without using an organic titanate.

Any of the above described phthalate-free chemiluminescent formulations can include a chemiluminescent component comprising between about 8 wt. % and about 10 wt. % bis(2,4,5-trichlorophenyl-6-carbopentoxyphenyl)oxalate, and between about 90 wt. % and 92 wt. % acetyl tributyl citrate; and an activator component comprising between about 1.5 wt. % and about 3.0 wt. % of hydrogen peroxide, between about 0.004 wt. % and about 0.006 wt. % sodium salicylate; and between about 96 wt. % and about 98 wt. % of pure triethyl citrate formed without using an organic titanate.

In another aspect, the invention provides a phthalate-free chemiluminescent formulation that includes a chemiluminescent component comprising an oxalate and a phthalate-free solvent, and an activator component comprising a hydrogen peroxide and a pure triethyl citrate formed without using an organic titanate. The phthalate-free chemiluminescent formulation also includes a fluorescer compound. The chemiluminescent component and the activator component are mixed together to produce chemiluminescent light. In one embodiment the phthalate-free solvent is a pure triethyl citrate. In another embodiment, the phthalate-free solvent is an acetyl tributyl citrate.

In yet another aspect, the invention provides a device containing a phthalate-free chemiluminescent formulation, which includes a first compartment and a second compartment. The first compartment contains a chemiluminescent component comprising an oxalate and a phthalate-free solvent. The second compartment contains an activator component comprising hydrogen peroxide and a phthalate-free solvent. The first compartment and second compartment are separated by a separating mean such as a packaging wall. When desired, the separating mean is broken or ruptured to mix the chemiluminescent component and the activator component to initiate a chemiluminescent reaction. In one embodiment, at least one of the phthalate-free solvents is a pure triethyl citrate formed without using an organic titanate. In a different embodiment, at least one of the phthalate-free solvents is an acetyl tributyl citrate.

Other aspects, objectives and advantages of the invention will become more apparent from the following detailed description when taken in conjunction with the accompanying drawings.

### DETAILED DESCRIPTION OF THE INVENTION

While the present invention is susceptible of embodiment in various forms, presently preferred embodiments are described with the understanding that the present disclosure is to be considered an exemplification of the invention and is not intended to limit the invention to the specific embodiment illustrated.

It should be further understood that the title of this section of this specification, namely, “Detailed Description Of The Invention”, relates to a requirement of the United States Patent Office, and does not imply, nor should be inferred to limit the subject matter disclosed herein.

According to an embodiment of the present invention, a chemiluminescent device, such as a glow stick, includes two or more compartments, each of which is separated from an adjacent compartment, for example, by a wall, such as a frangible, e.g., glass, vial. At least one compartment contains a chemiluminescent component, and at least one component includes an activator component. The chemiluminescent component generally includes an oxalate and a solvent, and the activator component generally includes hydrogen peroxide and a solvent. In this embodiment, both the chemiluminescent component solvent and the activator component solvent are phthalate-free solvents. The chemiluminescent component and the activator component are kept separated from each other by the wall. When desired, a user can open or rupture the wall to allow the two components to come in contact with each other to initiate a chemiluminescent reaction to generate a light. The chemiluminescent devices can be formed having various shapes and sizes, and can include multiple compartments containing the chemiluminescent components and the activator components.

The chemiluminescent component can include an oxalate selected from bis(2-carbalkoxy-3,4,6-trichlorophenyl) oxalate, e.g., the 2-carbobutoxy and 2-carbopentoxy compounds, bis(3-carbalkoxy-2,4,6-trichlorophenyl) oxalate, bis(4-carbalkoxy-2,3,6-trichlorophenyl)oxalate, bis(3,5-dicarbalkoxy-2,4,6-trichlorophenyl oxalate. Bis(2,3-dicarbalkoxy-4,5,6 trichlorophenyl)oxalate, bis(2,4-dicarbalkoxy-3,5,6-trichlorophenyl) oxalate, bis(2,5-dicarbalkoxy-3,4,6-trichlorophenyl)oxalate, bis(2,6-dicarbalkoxy-3,4,5-trichlorophenyl) oxalate, bis(3-carbalkoxy-2,4,5,6-tetrachlorophenyl)oxalate, bis(2-carbalkoxy-3,4,5,6-tetrachlorophenyl)oxalate, bis(4-carbalkoxy-2,3,5,6-tetrachlorophenyl) oxalate, bis(6-carbalkoxy-2,3,4-trichlorophenyl) oxalate, bis(2,3,-dicarbalkoxy-4,6-dichlorophenyl)oxalate, bis(3,6-dicarbalkoxy-2,4-dichlorophenyl)oxalate, bis(2,3,5-tricarbalkoxy-4,6-dichlorophenyl)oxalate, bis(3,4,5-tricarbalkoxy-2,6-dichlorophenyl)oxalate, bis(2,4,6-tricarbalkoxy-3,5-dichlorophenyl)oxalate, bis(3-bromo-6-carbohexoxy-2,4,5-trichlorophenyl)oxalate, bis(bis(3-bromo-2-carbethoxy-4,6-dichlorophenyl)oxalate, bis(2-carbethoxy-4,6-dichloro-3-nitrophenyl)oxalate, bis[2-carbomethoxy-4,6-dichloro-3-(trifluoromethyl)phenyl]oxalate, bis(2-carbobutoxy-46-dichloro-3-cyanophenyl)oxalate, bis(2-carboctyloxy-4,5,6-trichloro-3-ethoxyphenyl)oxalate, bis(2-carbobutoxy-3,4,6-trichloro-5-ethoxphenyl) oxalate, bis(2-carbisopropoxy-3,4,6-trichloro-5-methylphenyl)oxalate, bis(2-carbisopropoxy-4,6-dichloro-5 octylphenyl) oxalate, bis[2-carbomethoxy-3,5,6-trichloro-4-(1,1,3,3-tetramethylbutyl)phenyl]oxalate, bis{2-[carbobis(trifluoromethyl)methoxy]-3,4,5,6-tetrafluorophenyl}oxalate, bis(3,4,6-tribromo-2-carbocyclohexoxyphenyl)oxalate, bis(2,4,5-tribromo-6-carbophenoxy-3-hexadecylphenyl)oxalate, bis(2,4,5-trichloro-6-carbobutoxyphenyl)oxalate and bis(2,4,5-trichloro-6-carbopentoxyphenyl)oxalate.

The solvent for the chemiluminescent component is selected from phthalate-free solvents. The chemiluminescent component solvent provides sufficient solubility for the selected oxalate and other constituents, such that a desired concentration of an oxalate solution can be obtained. Suitable chemiluminescent solvents include, but are not limited to, carboxylic acid esters, such as ethyl acetate, ethyl benzoate, methyl formate, triacetin, and diethyl oxalate; salicylate esters, citrate esters, benzoates, mellitates, acetates, amides and alkyl aryl phosphates. In one embodiment, the solvent for the chemiluminescent component is selected from tributyl trimellitate, trihexyl trimellitate, benzyl benzoate, butyl benzoate, benzyl acetate, N,N-Diethyl toluamide, N,N-Diethyl Benzamide, -Butyl Tri-n-hexyl citrate, Ethyl 2-Acetoxy Salicylate, diisobutyl adipate, and acetyl tributyl citrate.

In some embodiments, the chemiluminescent component further includes a fluorescent compound. In such embodiments, the fluorescent compound is selected such that it is sufficiently soluble in the selected chemiluminescent component solvent. The fluorescent compound is stable in the presence of the hydrogen peroxide and the oxalate and has a spectral emission falling between about 330 millimicrons and 1200 millimicrons. Suitable fluorescent compounds include, but are not limited to, polycyclic aromatic compounds having at least three fused rings, such as anthracene, substituted anthracene, benzanthracene, phenanthrene, substituted phenanthrene, napthacene, substituted naphthacene, pentacene, substituted pentacene, perylene, substituted perylene, and the like. Typical substituents for all of these are phenyl, lower alkyl(C.sub.1-C.sub.6), chloro, bromo, cyano, alkoxy(C.sub.1-C.sub.16), and other like substituents which do not interfere with the light generating reaction contemplated herein.

The activator component includes a peroxide compound, a solvent and a catalyst. Examples of suitable peroxides include t-butylhydroperoxide, peroxybenzoic acid and hydrogen peroxide. Any suitable compound that produces hydrogen peroxide can also be used.

The activator component solvent is selected from phthalate-free solvents and provides a sufficient solubility and stability for the selected peroxide. Examples of suitable activator solvent include plasticizers such as trialkyl citrates, acetyl trialkyl citrates, dialkyl adipates, alkyl-substituted arylenesulfonamides, pentaerythritol tetrabenzoate, glyceryl tribenzoate, and mixtures thereof. In one embodiment, the activator solvent is selected from triethyl citrate, diisobutyl adipate, acetyl trialkyl citrate, N-ethyl-o,p-toluenesulfonamide, acetyl tributyl citrate and mixtures thereof.

In some embodiments, the activator component further includes a catalyst. Examples of suitable catalysts include sodium salicylate, tetrabutylammonium salicylate, lithium salicylate, potassium salicylate, rubidium chloride, lithium chloride, lithium sulfate, and tetrabutylammonium perchlorate.

In one embodiment, the fluorescent compound is included in the activator component rather than in the chemiluminescent component. In such an embodiment, the fluorescent compound is selected such that it is sufficiently soluble in the selected activator component solvent. In other embodiments, the fluorescent compound can be included in both the chemiluminescent component and the activator component.

In one embodiment, a phthalate-free chemiluminescent formulation includes a chemiluminescent component comprising between about 1 wt. % and about 20 wt. % bis(2,4,5-trichlorophenyl-6-carbopentoxyphenyl)oxalate (CPPO), preferably between about 5 wt. % and about 15 wt. % CPPO, more preferably between about 8 wt. % and about 10 wt. % CPPO; and between about 80 wt. % and about 99 wt. % of acetyl tributyl citrate (ATBC), preferably between about 85 wt. % and 95% wt. % ATBC, and more preferably between about 90 wt. % and 92 wt. % ATBC. The phthalate-free chemiluminescent formulation also includes an activator component comprising between about 1 wt. % and about 10 wt. % hydrogen peroxide (H₂O₂), preferable between about 1 wt. % and about 5 wt. % H₂O₂, more preferably between about 1.5 wt. % and 3.0 wt. % H₂O₂; and between about 0.001 wt. % and 0.010 wt. % sodium salicylate, preferably between about 0.003 wt. % and about 0.008 wt. % sodium salicylate, and more preferably between about 0.004 wt. % and about 0.006 wt. % sodium salicylate; and between about 85 wt. % and about 99 wt. % pure triethyl citrate formed without using an organic titanate, preferably between about 95 wt. % and 99 wt. % of pure triethyl citrate formed without using an organic titanate, and more preferably between about 96 wt. % and about 98 wt. % pure triethyl citrate formed without using an organic tinatanate.

### EXAMPLES AND TEST RESULTS

A sample of phthalate-free chemiluminescent formulation according an embodiment of the present invention was prepared and tested along with a sample of phthalate-free chemiluminescent formulation according to a different embodiment and a sample of chemiluminescent formulation including dimethyl phthalate. Sample 1 phthalate-free chemiluminescent formulation included an activator component comprising about 2.3 wt. % hydrogen peroxide (H₂O₂), about 0.005 wt. % sodium salicylate, and about 97.695 wt. % pure triethyl citrate, which was formed without using an organic titanate or alkoxylating an ester or filtering with molecular sieves, which is available through Jiangshu Leimeng Chemical Technology Co. (i.e. the triethyl citrate was not prepared using the method disclosed in U.S. Pat. No. 5,055,609 to Hull et al., wherein the triethyl citrate is prepared by the esterification process of heating an ethanol and citric acid in the presence of an organic titanate at a temperature of approximately 140° C., removing excess alcohol, and alkoxylating the ester by adding sulfuric acid and an appropriate anhydride while maintaining the temperature below approximately 110° C. until the alkoxylation reaction is complete to obtain the citrate ester).

Sample 2 phthalate-free chemiluminescent formulation included an activator component comprising about 2.3 wt. % hydrogen peroxide (H₂O₂), about 0.005 wt. % sodium salicylate, and about 97.695 wt. % triethyl citrate, which is not pure. Sample 3 chemiluminescent formulation included an activator component comprising about 2.3% hydrogen peroxide (H₂O₂), about 7.5 wt % tertiary butanol, about 0.005% sodium salicylate, and about 90.195 wt. % dimethyl phthalate. Table 1 shows light output results from the samples.

TABLE 1
Light Output*

| Type | KO** | 15 Min | 1 Hr | 2 Hr | 3 Hr | 4 Hr | 5 Hr | 6 Hr | 7 Hr | 8 Hr |
|---|---|---|---|---|---|---|---|---|---|---|
| Sample 1 | 640 | 14.32 | 10.57 | 7.59 | 5.18 | 3.3 | 1.85 | 1 | 0.523 | 0.301 |
| | 600 | 14.15 | 12.06 | 7.97 | 6.1 | 3.31 | 2.03 | 1.576 | 1.106 | 0.634 |
| Ave | 620 | 14.235 | 11.315 | 7.78 | 5.64 | 3.305 | 1.94 | 1.288 | 0.8145 | 0.4675 |
| Sample 2 | 347.452 | 44.751 | 21.934 | 8.244 | 2.952 | 1.273 | 0.716 | 0.416 | 0.289 | 0.241 |
| | 437.479 | 44.585 | 26.010 | 10.179 | 4.274 | 2.179 | 1.398 | 0.899 | 0.515 | 0.407 |
| Ave | 392.466 | 44.668 | 23.972 | 9.212 | 3.613 | 1.726 | 1.057 | 0.658 | 0.402 | 0.324 |
| Sample 3 | 719.921 | 30.730 | 17.728 | 11.071 | 7.750 | 5.650 | 5.397 | 3.733 | 2.649 | 2.029 |
| | 696.234 | 30.328 | 16.787 | 10.518 | 7.398 | 5.666 | 4.898 | 3.397 | 2.688 | 2.214 |
| Ave | 708.078 | 30.529 | 17.258 | 10.795 | 7.574 | 5.658 | 5.148 | 3.565 | 2.669 | 2.122 |

*The light output measurements are in lux.
**KO—Kick Off or initial light out put at activation.

As shown, Sample 1 including the pure triethyl citrate had a significantly better than light output results than Sample 2 including unpure triethyl citrate, and had a comparable light output results with Sample 3 including dimethyl phthalate.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context

What is claimed is:

1. A phthalate-free chemiluminescent formulation comprising:
a chemiluminescent component comprising:
an oxalate;
a first phthalate-free solvent;
an activator component comprising:
a hydrogen peroxide;
a second phthalate-free solvent;
a fluorescer compound; and
wherein the chemiluminescent component and the activator component are mixed together to produce a chemiluminescent light.

2. The formulation of claim 1, wherein the oxalate is bis(2,4,5-trichlorophenyl-6-carbopentoxyphenyl)oxalate.

3. The formulation of claim 1, wherein the first phthalate-free solvent and the second phthalate-free solvent are a same solvent.

4. The formulation of claim 1, wherein the first phthalate-free solvent and the second phthalate-free solvent are different solvents.

5. The formulation of claim 1, wherein at least one of the first and second phthalate-free solvent is a triethyl citrate.

6. The formulation of claim 1, wherein at least one of the first and second phthalate-free solvent is an acetyl tributyl citrate.

7. The formulation of claim 1, wherein the first phthalate-free solvent is an acetyl tributyl citrate.

8. The formulation of claim 1, wherein the second phthalate-free solvent is a pure triethyl citrate formed without using an organic titanate.

9. The formulation of claim 1, wherein the fluorescer compound is included in the chemiluminescent component.

10. The formulation of claim 1, wherein the flourescer compound is included in the activator component.

11. The formulation of claim 1, wherein the chemiluminescent component includes between about 5 wt. % and about 15 wt. % bis(2,4,5-trichlorophenyl-6-carbopentoxyphenyl)oxalate, and between about 85 wt. % and 95 wt. % acetyl tributyl citrate.

12. The formulation of claim 1, wherein the activator component includes between about 1 wt. % and about 5 wt. % of hydrogen peroxide; and between about 0.003 wt. % and about 0.008 wt. % sodium salicylate; and between about 95 wt. % and about 99 wt. % of pure triethyl citrate formed without using an organic titanate.

13. The formulation of claim 1, wherein the chemiluminescent component includes between about 8 wt. % and about 10 wt. % bis(2,4,5-trichlorophenyl-6-carbopentoxyphenyl)oxalate, and between about 90 wt. % and 92 wt. % acetyl tributyl citrate; and the activator component includes between about 1.5 wt. % and about 3.0 wt. % of hydrogen peroxide, between about 0.004 wt. % and about 0.006 wt. % sodium salicylate, and between about 96 wt. % and about 98 wt. % of pure triethyl citrate formed without using an organic titanate.

14. A phthalate-free chemiluminescent formulation comprising:
a chemiluminescent component comprising:
an oxalate;
a phthalate-free solvent;
an activator component comprising:
a hydrogen peroxide;
a pure triethyl citrate formed without using an organic titanate;
a fluorescer compound; and
wherein the chemiluminescent component and the activator component are mixed together to produce a chemiluminescent light.

15. The formulation of claim 14, wherein the phthalate-free solvent is a pure triethyl citrate.

16. The formulation of claim 14, wherein the phthalate-free solvent is an acetyl tributyl citrate.

17. The formulation of claim 14, wherein the oxalate is a bis(2,4,5-trichlorophenyl-6-carbopentoxyphenyl)oxalate and the phthalate-free solvent is an acetyl tributyl citrate.

18. A devise containing a phthalate-free chemiluminescent formulation, comprising:
a first compartment containing a chemiluminescent component, the chemiluminescent component comprising:
an oxalate;
a first phthalate-free solvent;
a second compartment containing an activator component comprising:
a hydrogen peroxide;
a second phthalate-free solvent;
wherein the first compartment and second compartment are separated by a separating mean; and wherein
the separating mean is broken to mix the chemiluminescent component and the activator component to initiate a chemiluminescent reaction.

19. The devise of claim 18, wherein at least one of the first and second phthalate-free solvents is a pure triethyl citrate formed without using an organic titanate.

20. The devise of claim 18, wherein at least one of the first and second phthalate-free solvents is an acetyl tributyl citrate.
